(19) United States
(12) Patent Application Publication
(10) Pub. No.: US 2007/0244813 A1
(43) Pub. Date: Oct. 18, 2007

(54) System That Realizes Fund Transfer by Mobile Telephone Short Message Confirming Mode and Method Thereof

(76) Inventor: Xing Zhou, Guangdong (CN)

Correspondence Address: MYERS DAWES ANDRAS & SHERMAN, LLP, 19900 MACARTHUR BLVD.,, SUITE 1150, IRVINE, CA, 92612, US

(21) Appl. No.: 11/661,044

(22) PCT Filed: Aug. 22, 2005
(86) PCT No.: PCT/CN05/01312

§ 371 Date: Feb. 22, 2007

(30) Foreign Application Priority Data
Aug. 25, 2004 (CN) 200410051218.6

(51) Int. Cl. G06Q 40/00

(52) U.S. Cl. 705/40

(57) ABSTRACT

The present invention relates to a system which implements bank transactions and records the method thereof, and provides a system that realizes transfer of funds by mobile telephone with a short message confirming mode and method thereof. The system of the present invention comprises a server in a bank, a confirming module, a bank transfer business-processing module, a transfer operation terminal, and a short message transmitting/receiving module. The method of the present invention includes a short message transmitting/receiving module that informs the account holder of the transferring request in a short message before the bank account fund changes, and then forwards the confirmation message to the confirming module which identifies the account holders according to a reserved certificate. It then receives the account holder's fund-allocating command, and starts the bank transfer business processing module to perform the fund-allocating operation. The present invention enables account holders to have real-time control over the changing status of the funds in their bank accounts and to efficiently avoid the risk of the account holders' account funds being randomly allocated. Furthermore, it protects the account holder from unauthorized withdrawals if the account holder loses his credit card, his passbook or debit card, or has his note password or signature stolen.

### TECHNICAL FIELD

The present invention relates to a system which implements bank transactions and also supplies the method thereof, and especially provides a system that realizes fund transfer by mobile telephones with short messages confirming mode and method thereof.

### BACKGROUND ART

In the modern developed economic society, bank account holders usually rely on the allocating banks to transfer funds among people and enterprises. The security issue of the fund transfer has received extensive attention. With the credit card used more and more extensively, the account holders may experience large economic loss because of lost or stolen credit cards when unauthorized people may gain access to their card. Similarly, for the individual saving account, enterprise accounts and so on, the account holders may undergo severe economic loss if the account holders lose their bank book or debit card, or have their passports and signatures stolen; furthermore, their funds may be randomly allocated or unauthorized withdrawals may be made thereafter.

With the present technology, account holders usually rely on reporting their lost cards to the bank to prevent their funds from being withdrawn randomly by others. However, in reality, the report of the loss often cannot be done in time, which makes the economic loss of the account holders difficult or even impossible to redeem. Usually, if the reporting of the loss cannot be done immediately when the account holder loses his credit card, passbook or debit card, or when the note password or signature has been stolen, he would have no idea what to do. In terms of the situations mentioned above, there is no effective method to solve these problems with today's present technology.

### SUMMARY OF THE INVENTION

It is a general object of the present invention to provide a system that transfer funds by a mobile telephone short message confirming mode. The present invention enables account holders to have real time control over a fund's changing status, and to efficiently avoid risks when funds are randomly allocated or unauthorized withdrawals have been made if an account holder loses his credit card, passbook or debit card, or has his note password or signature stolen.

The system that transfer funds by a mobile telephone short message confirming mode according to the present invention comprises a server in a bank, a confirming module, a bank transfer business-processing module, a transfer operation terminal, and a short message transmitting/receiving module.

The said server in the bank is deposited when the bank account is opened by the account holder as a financial account. The server is bonded with the mobile phone of the account holder; the said server in the bank is connected to the confirming module and with the bank transfer business-processing module through a special network system.

The said confirming module is reserved with certificates that the account holder attained with the bank before. The module receives and analyzes confirmation messages about the fund transfer from the account holder's mobile phone, which is transmitted from the said server in the bank. Then the confirming module can compare and differentiate the said message with those agreed upon before, to identify the account holder and send the transfer operation command to the bank transfer business-processing module according to the request of the account holder. The said reserved certificates contain individual information related to the identity of the account holder, which has been agreed upon by both the holder and bank in advance.

The said bank transfer business-processing module receives and deals with the transfer operation command from the said confirming module and then feeds back the transfer operation results to the said transfer operation terminal through the server in the bank.

The said transfer operation terminal which is connected to the said server in the bank through the public Internet or a special network, receives the transfer operation results from the transfer operation terminal; the said transfer operation terminal is connected to the short message transmitting/receiving module and delivers the transfer request message.

The said short message transmitting/receiving module, which is the equipment used to deliver and receive the short messages, is connected to the said server in the bank through a public or special network; the said short message transmitting/receiving module receives and analyzes transfer request messages from the said transfer operation terminal, then codes and sends short messages to the said account holders' mobile phone that has been bonded with the bank account. Information is automatically examined and receives a confirmation message from the account holders' mobile phone and then transmits the messages to the said server in the bank.

The said system further includes: the said transfer operation terminal that transmits the fund transfer results from the server in the bank to the said short message transmitting/receiving module, and then codes and sends short messages to the said account holders' mobile phone that was bonded with the bank account.

In this system, the said bank account is at least one of the following: an individual credit card account, an individual saving account, an enterprise account, an inter-bank deposit, and a national treasury account.

In this system, the said short message is at least one of the following: word message, voice message, image message, and the combination thereof.

In this system, the said transfer operation terminal is at least one of the following: the card-sliding transfer operation terminal in the consumer market, the card-sliding transfer operation terminal at the bank business counter, and a manual transfer operation terminal at the bank business counter.

In this system, the said transfer operation terminal and the short message transmitting/receiving module can be collected by a special network; or may be combined with the said transfer operation terminal and the short message transmitting/receiving module into a device, and then they can be connected to each other through an inner interface.

In this system, the said short message transmitting/receiving module is at least one of the following: a mobile phone or a telephone which contains the chip or software for transmitting/receiving short messages, a computer which can transmit a mobile phone short message through the Internet, and a specially manufactured device to transmit and receive short messages.

In this system, the said reserved certificates contain individual information related to the identity of the account holder agreed upon by both the holder and the bank in advance, such as the fingerprint of the holder scanned and kept in the mobile phone as a reserved certificate, or a specific photo, or the pictures drawn by the account holder, or the signature of the account holder, or the voice recorded by the mobile phone. All the above reserved certificates can be sent to the bank confirming module by the mobile phone to identify the account holder's identity by recognizing the corresponding picture and/or voice.

In this system, the said reserved certificates and confirming modules can be compared in the following ways:

The said reserved certificates are the passports that consist of numbers and English letters, and the said confirming module is a device that can differentiate the passport's numbers or letters.

The said reserved certificates are the specific voice or music recorded by the account holder, and the said confirming module is the telephone recording device or the audio frequency recognition device.

The said reserved certificate is the account holder's mobile phone number or the international mobile equipment identity of the mobile telephone and the said confirming module is a recognition device for an account holder's electronic character.

The said reserved certificate is an account holder's fingerprint, and the said confirming module is a fingerprint recognition device.

The said reserved certificate is an account holder's signature or seal, and the said confirming module is a signature recognition device.

The said reserved certificate is an appointed picture by the account holder, and the said confirming module is a picture recognition device.

In another method, the said confirming module is the bank's manual confirming module that examines directly whether an account holder's confirming message is received and confirms an account holder's identity.

The present invention also provides a method for realizing fund transfer by using a mobile telephone short message confirming mode.

The said method according to the present invention for realizing fund transfer by a mobile telephone short message confirming mode comprises the steps of:

(a) The account holder opens a bank account in a bank which has been bonded with his mobile phone;

(b) The account holder stipulates the reserved certificates with the bank and saves them in a confirming module;

(c) The transfer operation terminal sends the transfer request information to the short message transmitting/receiving module through a special network or an inner interface;

(d) The short message transmitting/receiving module receives and analyzes the transfer request information from a transfer operation terminal, then codes and sends short messages to the account holder's mobile phone that has been bonded with the bank account;

(e) The short message transmitting/receiving module automatically examines whether the confirming short message sent by the account holder is received. If the confirming short message is received, the short message transmitting/receiving module sends the message to the server in the bank through a special network or the public Internet; otherwise, the short message transmitting/receiving module feeds the information back to the transfer operation terminal and the transfer operation is terminated;

(f) The server in the bank receives and transfers a confirming message to the confirming module, which includes the information regarding the examination of the account holder's identity and a transfer confirmation message;

(g) The confirming module compares and identifies the examination information of the account holder's identity with the reserved certificate; if the account holder's identity is confirmed, the confirming module sends the transfer operation command to the bank transfer business-processing module according to the account holder's order; otherwise, the confirming module feeds back to the transfer operation terminal through the server in the bank and the transfer operation terminates;

(h) The bank transfer business-processing module receives and deals with transfer operation commands from the confirming module through a special network, and then feeds back the results of the transfer operation to a transfer operation terminal through a server in the bank.

This method further comprises the step of: after the step h, the said transfer operation terminal transmits the transfer operation results from a server in the bank to the said short message transmitting/receiving module, and then codes and sends short messages to an account holder's mobile phone that has been bonded with the bank account.

In this method, in the step e, the said short message transmitting/receiving module is set with an automatic test parameter including the test times and the distant time of each test.

The present invention also provides another method for realizing fund transfer by a mobile telephone short message confirming mode.

The said method according to the present invention for realizing fund transfer by a mobile telephone short message confirming mode comprises the steps of:

(a) An account holder opens a bank account in the bank which has been bonded with his mobile phone;

(b) The account holder stipulates the reserved certificates with the bank and saves them in a confirming module;

(c) The transfer operation terminal sends the transfer request information to a short message transmitting/receiving module through a special network or an inner interface;

(d) The short message transmitting/receiving module receives and analyzes the transfer request information from a transfer operation terminal, then codes and sends short messages to an account holder's mobile phone that has been bonded with the bank account;

(e) The bank manual confirming module automatically examines whether the confirming call made by the account holder has been received; if the confirming call was received, a confirmation of the account holder's identity is conducted; otherwise, the information is fed back to the transfer operation terminal and the transfer operation is terminated;

(f) If the account holder's identity is confirmed, the bank's manual confirming module sends the transfer operation command to a bank transfer business-processing module according to the account holder's orders; otherwise, it feeds it back to the transfer operation terminal through a server in the bank and the transfer operation is terminated;

(g) The bank transfer business-processing module receives and deals with the transfer operation command from the confirming module through a special network, and then feeds back the results of the transfer operation to the transfer operation terminal through a server in the bank.

This method further comprises the step of: after the step g, the said transfer operation terminal transmits the transfer operation results from the server in the bank to the said short message transmitting/receiving module, and then codes and sends short messages to the account holder's mobile phone that has been bonded with the bank account.

In this method, in the step e, the bank manual confirming module is set up with an automatic examination parameter including the test times and the distant time of each test.

The said system according to the present invention that realizes fund transfer by a mobile telephone short message confirming mode and the method thereof solves the problems that exist in present technology and possesses the following virtues:

(1) The present invention provides a new mode of fund transfer with confirmation by the account holder through mobile phone short messages when the fund is allocated, it also utilizes the mutual supervision of the account holder and the bank before the fund is allocated. It also enables the account holders to have real-time control over the changing status of their bank account funds, to efficiently avoid risks when the account holders' funds are randomly allocated or when there are unauthorized withdrawals in the case that the account holder loses his credit card, passbook or debit card, or has his note password or signature stolen. With this new technology the security of the account holder's fund is assured.

(2) The implementation of the present invention is simple; it can use existing equipment such as the present bank system, the transfer operation terminal, etc, and the present mobile telecommunication technology to combine with various platforms and technologies, and then make improvements according to the technical methods according to the present invention; the system deployment can be accomplished thereafter and would spread rapidly.

(3) Due to the diploid confirmation system of reserved certificates and the mobile phone short messages offered by enterprises in the bank, this invention would protect the security of enterprise funds in bank accounts in a better way and also enable enterprises to manage the cash flow situations of their company's capital. Enterprise management would become more convenient.

### BRIEF DESCRIPTION OF THE DRAWINGS

FIG. 1 is a perspective view illustrating a system according to the present invention that realizes fund transfer by using a mobile telephone short message confirming mode.

FIG. 2 is the flow chart illustrating one method according to the present invention that realizes fund transfer by a mobile telephone short message confirming mode.

FIG. 3 is the flow chart illustrating another method according to the present invention that realizes fund transfer by a mobile telephone short message confirming mode.

### DETAILED DESCRIPTION OF THE INVENTION

The following further illustrate the specific implementation methods of this invention according to the attached pictures.

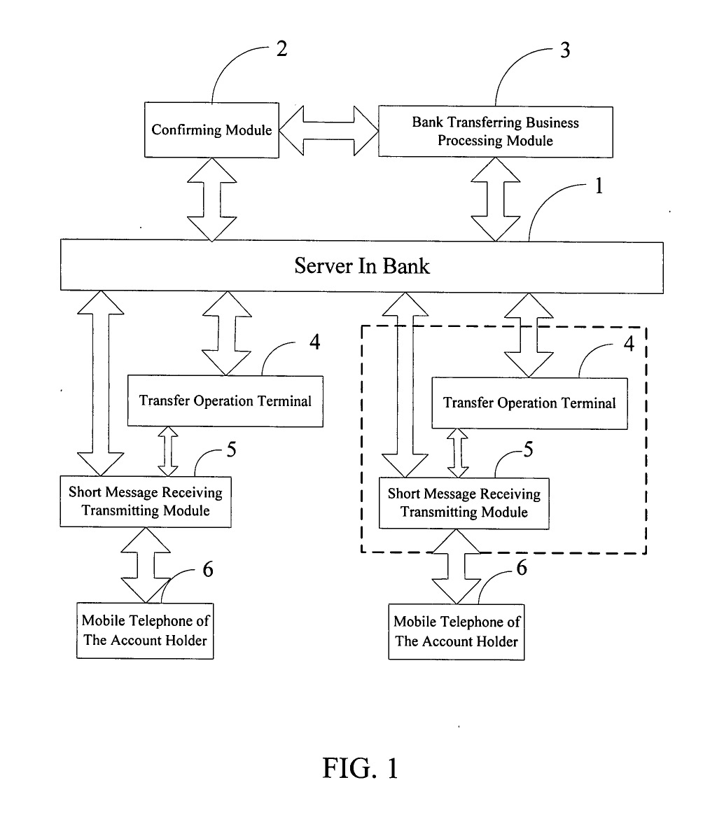

Schematically illustrated in FIG. 1, the said system according to the present invention that realizes fund transfer by a mobile telephone short message confirming mode comprises a server in the bank 1, confirming module 2, the bank transfer business-processing module 3, transfer operation terminal 4 and a short message transmitting/receiving module 5.

The said server in the bank 1 is deposited when the bank account is opened by an account holder as a fund account, which is bonded to the mobile phone of an account holder 6; the said server in the bank 1 is connected to a confirming module 2 and the bank transfer business-processing module 3 through a special network system.

The said confirming module 2 is reserved with certificates that the account holders set up with the bank. It receives and analyzes confirmation messages about fund transfers from the mobile phones of the account holders 6, which are transmitted from a server in the bank 1. Then the confirming module compares and differentiates between the said messages with information left before to identify the account holder and sends the transferring operation commands to the bank transfer business-processing module 3 according to the request of the account holder; the said reserved certificates ascertain individual information related to the identity of the account holders. This information was agreed upon by both the holder and bank in advance.

A bank transfer business-processing module 3 receives and deals with a transfer operation command from the confirming module 2, and then feeds back the transfer operation results to a transfer operation terminal 4 through a server in the bank 1.

The said transfer operation terminal 4 is connected to the said server in the bank 1 through a public or special network to receive the transfer operation results from a server in the bank 1; the said transfer operation terminal 4 is connected to a short message transmitting/receiving module 5 and delivers the transfer request messages.

The said short message transmitting/receiving module 5, which is the equipment used to deliver and receive short messages, is connected to the said server in the bank I through a public or special network; the said short message transmitting/receiving module 5 receives and analyzes the transfer request message from the said transfer operation terminal 4, then codes and sends short messages to the said account holders' mobile phone 6 that has been bonded with the bank account. It automatically examines and receives the confirmation message from the account holders' mobile phone 6 and then transmits the message to the said server in the bank 1.

The said system further includes: the said transfer operation terminal 4 that transmits the fund transfer results from the server in the bank 1 to the said short message transmitting/receiving module 5, and then codes and sends short messages to the said account holders' mobile phone 6 that has been bonded with the bank account.

Schematically illustrated in FIG. 1, the said transfer operation terminal 4 and the short message transmitting/receiving module 5 can be connected in different way; as shown in the left example, they are independent of each other and are connected through a special network; as shown in the right example. They are combined as a device which is connected through an inner interface.

### EXAMPLE 1

### Fund Transfer in Payment by Credit Card

In this example, the said transfer operation terminal is the card-sliding transfer operation terminal in the consumer market; the said short message transmitting/receiving module is the mobile phone or the telephone which contains the chip or software for transmitting/receiving short messages, or the computer which can transmit the mobile phone's short messages through the Internet, or the specially manufactured device made to transmit and receive short messages.

In this example, the said transfer operation terminal and the short message transmitting/receiving module can be connected by a special network system; or may be combined with the said transfer operation terminal and the short message transmitting/receiving module into a device and then they can be connected to each other through an inner interface.

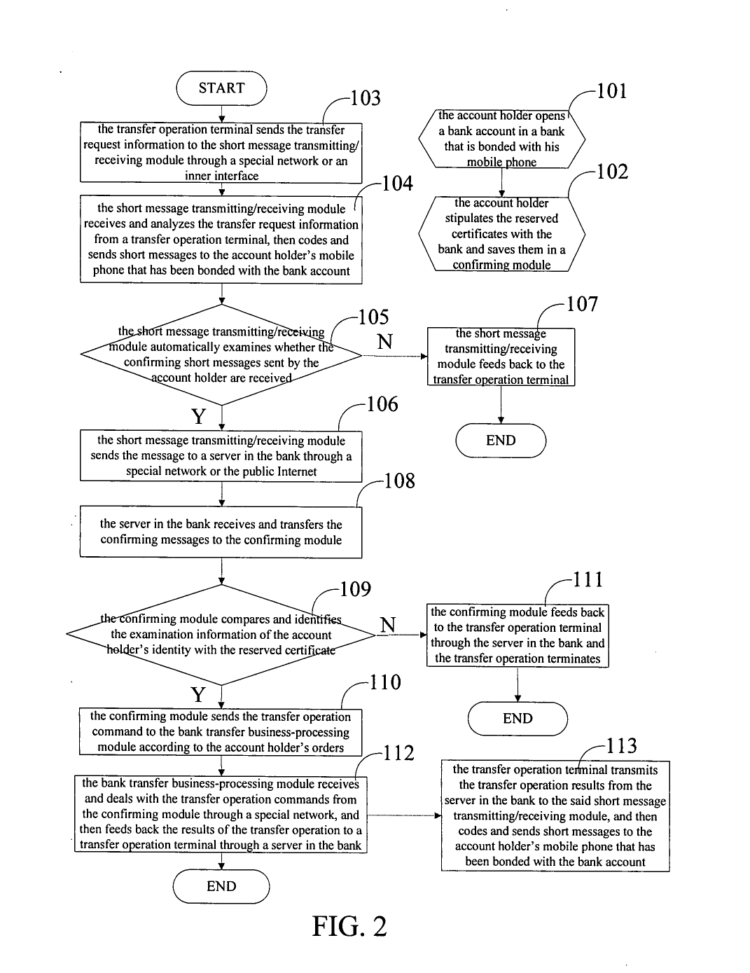

The said method according to the present invention for realizing fund transfer by a mobile telephone's short message confirmation mode is schematically illustrated in FIG. 2.

Initially, an account holder opens a bank account in the bank which is bonded with his mobile phone, which is step 101.

Next, the account holder stipulates the reserved certificates with the bank and saves them in a confirming module, which is step 102.

When a person uses the said credit card above for payment in the consumer market at a hotel, bar or emporium, the card-sliding transfer operation terminal sends the transfer request message to a short message transmitting/receiving module through a special network or the inner interface after the clerk slides the card, which is step 103. A short message transmitting/receiving module receives and analyzes the transfer request information from the transfer operation terminal, then codes and sends short messages to the account holder's mobile phone that has been bonded with the bank account, which is step 104, and the short message's contents are then related to the bank account, including the volume of the transfer fund, and the fund receiving account or institution. The short message transmitting/receiving module automatically examines whether the confirming short message from the account holder's mobile phone has been received, which is step 105. If the confirming short message is received, the short message transmitting/receiving module sends the message to a server in the bank through a special network or the public Internet, which is step 106; otherwise, the short message transmitting/receiving module feeds back to the card-sliding transfer operation terminal, which is step 107, and the transfer operation is terminated. A server in the bank receives and transfers the confirming messages to a confirming module, which includes the information about the examination of the account holder's identity and the transfer confirmation message, which is step 108.

A confirming module compares and identifies the examination information of the account holder's identity with the reserved certificate, which is step 109; if the account holder's identity is confirmed, the confirming module sends the transfer operation command to the bank transfer business-processing module according to the account holder's orders, including the order to, or refusal to, transfer funds, which is step 110; otherwise, the confirming module feeds back to the transfer operation terminal through a server in the bank, which is step 111, and the transfer operation terminates. The bank transfer business-processing module receives and deals with a transfer operation command from a confirming module through a special network, and then feeds back the results of the transfer operation to a transfer operation terminal through a server in the bank, which is step 112, and the transfer operation terminates when the bill of exchange document is printed.

After a successful transfer operation is processed in step 112, the process of informing the account holder can be added, which is step 113. A card-sliding transfer operation terminal transmits the transfer operation results from a server in the bank to a short message transmitting/receiving module, then codes and sends short messages to an account holder's mobile phone that has been bonded with the bank account.

In the said method above, the said reserved certificates are the individual information related to the identity of the account holder agreed upon by both the holder and the bank in advance, such as a fingerprint of the holder scanned and kept in the mobile phone as a reserved certificate, or a specific photo, or pictures drawn by the account holder, or the signature of the account holder, or the voice recorded by the mobile phone. All the above reserved certificates can be sent to the bank confirming module by the mobile phone to identify the account holder's identity by recognizing the corresponding picture and/or voice.

In the said method above, the said reserved certificates and confirming modules can be corresponded in the following ways:

The said reserved certificates are passports consisting of numbers and English letters, and the said confirming module is a device for differentiating the passport's numbers or letters.

The said reserved certificates are the specific voice or music recorded by the account holder, and the said confirming module is a telephone recording device or an audio frequency recognition device.

The said reserved certificates are the account holder's mobile phone number or the international mobile equipment identity of the mobile phone, and the said confirming module is a recognition device for the account holder's electronic character.

The said reserved certificate is an account holder's fingerprint, and the said confirming module is a fingerprint recognition device.

The said reserved certificate is an account holder's signature or seal, and the said confirming module is a signature recognition device.

The said reserved certificate is the appointed picture by an account holder, and the said confirming module is a picture recognition device.

In the said method above, the said confirming module receives the specific word, picture or short voice messages sent from an account holder's mobile phone and compares and identifies them with the reserved certificates kept in the confirming module.

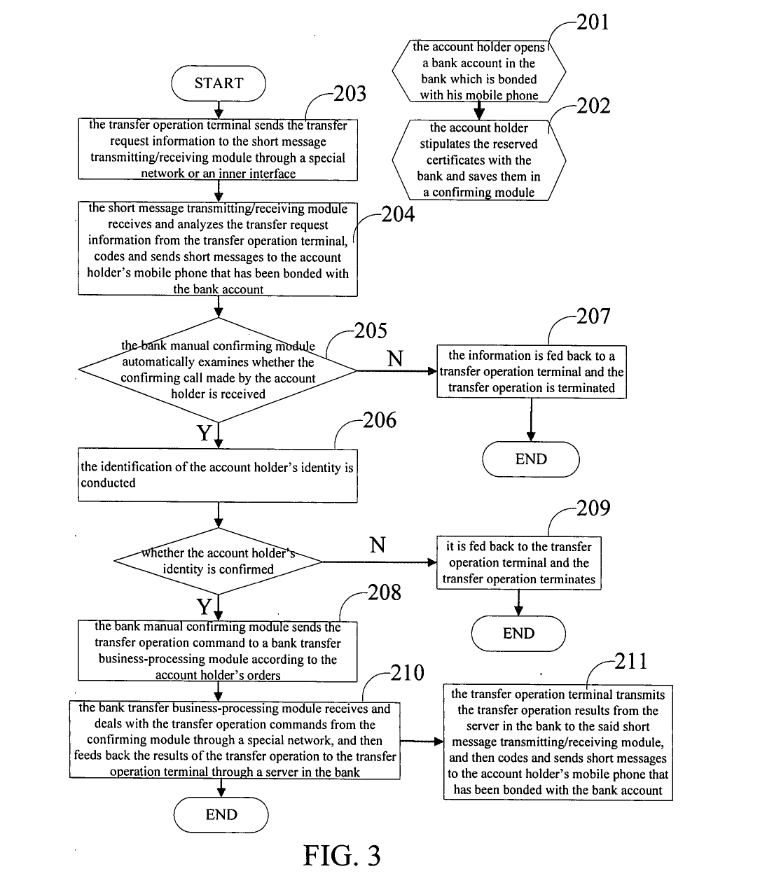

The said method according to the present invention that realizes fund transfer by a mobile telephone short message confirming mode may also be schematically illustrated in FIG. 3.

Initially, an account holder opens a bank account in the bank which is bond with his mobile phone, which is step 201.

Next, the account holder stipulates the reserved certificates with the bank and saves them in a confirming module, which is step 202.

When a person uses the said credit card above for payment in a consumer's market such as a hotel, bar or emporium, the card-sliding transfer operation terminal sends a transfer request message to a short message transmitting/receiving module through a special network or an inner interface after the clerk slides the card, which is step 203 The short message transmitting/receiving module receives and analyzes the transfer request information from the transfer operation terminal, then codes and sends short messages to the account holder's mobile phone that has been bonded with the bank account, which is step 204, and the short message's contents contain the related information, such as the bank account number, the volume of the transfer fund, and the fund receiving account or institution. The bank manual confirming module automatically examines whether the confirming call from the account holder's mobile phone is received, which is step 205. If the confirming call is received, the identification of the account holder's identity is conducted, which is step 206; otherwise, it feeds back to the card-sliding transfer operation terminal, which is step 207, and the transfer operation is terminated. If the account holder's identity is confirmed, the bank manual confirming module sends the transfer operation command to the bank transfer business-processing module according to the accountholder's order, which is step 208; otherwise, it feeds the information back to the transfer operation terminal, which is step 209, and the transfer operation terminates. The bank transfer business-processing module receives and deals with the transfer operation command from the bank's manual confirming module through a special network, and then feeds back the results of the transfer operation to a transfer operation terminal through a server in the bank, which is step 210, and the transfer operation terminates when a bill of exchange document is printed.

After a successful transfer operation in step 210, the process of informing the account holder can be added, which is step 211. The card-sliding transfer operation terminal transmits the transfer operation results from a server in the bank to a short message transmitting/receiving module, then codes and sends short messages to the account holder's mobile phone that has been bonded with the bank account.

### EXAMPLE 2

### Fund Transfer from the Individual Debit Account

In this example, the said transfer operation terminal is the card-sliding transfer operation terminal at a bank business counter; the said short message transmitting/receiving module is the mobile phone or the telephone which contains the chip or software for transmitting/receiving short messages, or a computer that can transmit mobile phone short messages through the Internet, or a specially manufactured device to transmit and receive short messages.

In this example, the said card-sliding transfer operation terminal and the short message transmitting/receiving module, as well as the confirming module is connected by a special network system; or may be combined with the said transfer operation terminal and the short message transmitting/receiving module, as well as the confirming module into a device, and then they can connect to each other through an inner interface.

The said method according to the present invention that realizes fund transfer by the mobile telephone short message confirming mode is schematically illustrated in FIG. 2.

Initially, an account holder opens a bank account in the bank which is bonded with his mobile phone, which is step 101.

Next, the account holder stipulates the reserved certificates with the bank and saves them in the confirming module, which is step 102.

When a person transfers funds with a bankbook, debit card or credit card from the bank, the card-sliding transfer operation terminal sends the transfer request message to the short message transmitting/receiving module through a special network or an inner interface after the bank clerk slides the card, which is step 103. The short message transmitting/receiving module receives and analyzes the transfer request information from the transfer operation terminal, then codes and sends short messages to the account holder's mobile phone bonded with the bank account, which is step 104, and the short messages contain related information such as the bank account number, the volume of the transfer fund, and the fund receiving account or institution. The short message transmitting/receiving module automatically examines whether the confirming short message from the account holder's mobile phone is received, which is step 105. If the confirming short message is received, the short message transmitting/receiving module would send the message to the server in the bank through a special network system or the public Internet, which is step 106; otherwise, the short message transmitting/receiving module feeds back to the card-sliding transfer operation terminal, which is step 107, and the transfer operation is terminated. A server in the bank receives and transfers the confirming messages to the confirming module, which includes the information about the examination of the account holder's identity and the transfer confirmation message, which is step 108. The confirming module compares and identifies the examination information of the account holder's identity with the reserved certificate, which is step 109; if the account holder's identity is confirmed, the confirming module sends the transfer operation command to the bank transfer business-processing module according to the account holder's order, including the order to or refusal to transfer funds, which is step 110;otherwise, the confirming module feeds back to the transfer operation terminal through the server in the bank, which is step 111, and the transfer operation terminates. The bank transfers business-processing module receives and deals with the transfer operation command from the confirming module through a special network, and then feeds back the results of the transfer operation to a transfer operation terminal through a server in the bank, which is step 112, and the transfer operation terminates with the bill of exchange document printed.

After the successful transfer operation is in step 112, the process of informing the account holder can be added, which is step 113. A card-sliding transfer operation terminal transmits the transfer operation results from a server in the bank to a short message transmitting/receiving module, then codes and sends short messages to the account holder's mobile phone that has been bonded with the bank account.

In the said method above, the said reserved certificate has individual information related to the identity of the account holder agreed upon by both the holder and the bank in advance, such as a fingerprint of the holder scanned and kept in the mobile phone as a reserved certificate, or a specific photo, or a picture drawn by the account holder, or the signature of the account holder, or the voice recorded by a mobile phone. All the above reserved certificates can be sent to a bank confirming module by a mobile phone to identify the account holder's identity by recognizing the corresponding picture and/or voice.

In the said method above, the said reserved certificates and confirming module can be corresponded in the following ways:

The said reserved certificates are passports written with numbers and English letters, and the said confirming module is the device to differentiate the passport of numbers or letters.

The said reserved certificates are the specific voice or music recorded by the account holder, and the said confirming module is a telephone recording device or an audio frequency recognition device.

The said reserved certificates are the account holder's mobile phone number or the international mobile equipment identity of the mobile phone, and the said confirming module is a recognition device for the account holder's electronic character.

The said reserved certificate is the account holder's fingerprint, and the said confirming module is a fingerprint recognition device.

The said reserved certificate is the account holder's signature or seal, and the said confirming module is a signature recognition device.

The said reserved certificate is an appointed picture by the account holder, and the said confirming module is a picture recognition device.

In the method above, the said confirming module receives the specific word, picture or voice messages sent from the account holder's mobile phone and compares and identifies them with the reserved certificates kept in the confirming module.

The said method according to the present invention that realizes fund transfer by mobile telephone short message confirming mode is schematically illustrated in FIG. 3.

Initially, an account holder opens a bank account in the bank which is bonded with his mobile phone, which is step 201.

Next, the account holder stipulates the reserved certificates with the bank and saves them in the confirming module, which is step 202.

When people transfer funds with a bankbook, debit card or credit card in the bank, the card-sliding transfer operation terminal sends the transfer request message to the short message transmitting/receiving module through a special network or an inner interface after the bank clerk slides the card, which is step 203. The short message transmitting/receiving module receives and analyzes the transfer request information from the transfer operation terminal, codes and sends short messages to the account holder's mobile phone that has been bonded with the bank account, which is step 204, and the contents of the short message contain related information such as the bank account number, the volume of the transfer fund, the fund receiving account and institution. The bank's manual confirming module automatically examines whether the confirming call from the account holder's mobile phone is received, which is step 205. If the confirming call is received, the confirmation of the account holder's identity is conducted, which is step 206; otherwise, it feeds it back to the transfer operation terminal, which is step 207, and the transfer operation is terminated. If the accountholder's identity is confirmed, the bank's manual confirming module sends the transfer operation command to the bank transfer business-processing module according to the account holder's orders, which is step 208; otherwise, it feeds the information back to the transfer operation terminal, which is step 209,and the transfer operation terminates. The bank transfer business-processing module receives and deals with the transfer operation command from the bank manual confirming module through a special network, and then feeds back the results of the transfer operation to the transfer operation terminal through the server in the bank, which is step 210, and the transfer operation terminates when the bill of the exchange document is printed.

After the successful transfer operation in step 210, the process of informing the account holder is added, which is step 211, the card-sliding transfer operation terminal transmits the transfer operation results from the server in the bank to a short message transmitting/receiving module, then codes and sends short messages to the account holder's mobile phone bonded with the bank account.

### EXAMPLE 3

### Fund Transfer from the Enterprise Accounts

In this example, the said transfer operation terminal is the card-sliding transfer operation terminal at the bank business counter; the said short message transmitting/receiving module is the mobile phone or the telephone which contains the chip or software for transmitting/receiving short messages, or the computer which can transmit the mobile phone's short messages through the Internet, or specially manufactured devices to transmit and receive short messages.

In this example, the said card-sliding transfer operation terminal and the short message transmitting/receiving module as well as the confirming module are connected by a special network; or are combined with the said transfer operation terminal and a short message transmitting/receiving module as well as a confirming module into a device and then they can be connected to each other through an inner interface.

The said method according to the present invention that realizes fund transfer by a mobile telephone short message confirming mode is schematically illustrated in FIG. 2.

Initially, the account holder opens a bank account in the bank which has been bonded with his mobile phone, which is step 101.

Next, the account holder stipulates the reserved certificates with the bank and saves them in a confirming module, which is step 102.

When people transfer funds with a check or draft from their enterprise, the bank staff inputs the enterprise's bank account to a manual transfer operation terminal after confirming that the seal of the check or draft is consistent with that reserved in the bank by the enterprise. The manual transfer operation terminal sends the transfer request message to the short message transmitting/receiving module through a special network or an inner interface which is step 103. The short message transmitting/receiving module receives and analyzes the transfer request information from the transfer operation terminal, codes and sends short messages to the legal representative's mobile phone bonded with the said enterprise's bank account, which is step 104. The contents of the short message contain related information such as the bank account number, the volume of the transfer fund, the fund receiving account or institution. The short message transmitting/receiving module automatically examines whether the confirming short message from the account holder's mobile phone is received, which is step 105. If the confirming short message is received, the short message transmitting/receiving module sends the message to the server in the bank through a special network or a public Internet, which is step 106; otherwise, the short message transmitting/receiving module feeds back to the manual transfer operation terminal, which is step 107, and the transfer operation is terminated. The server in the bank receives and transfers the confirming messages to a confirming module, which includes the information about the examination of the legal representative's identity and the transfer confirmation message, which is step 108. The confirming module compares and identifies the examination information of the legal representative's identity with a reserved certificate, which is step 109; if the legal representative's identity is correct, the confirming module sends a transfer operation command to the bank transfer business-processing module according to the account holder's orders, including the order to, or refusal to, transfer the funds, which is step 110; otherwise, the confirming module feeds back to the manual transfer operation terminal, which is step 111, and the transfer operation terminates. The bank transfer business-processing module receives and deals with transfer operation commands from a confirming module through a special network, and then feeds back the results of the transfer operation to a transfer operation terminal through a server in the bank, which is step 112, and the transfer operation terminates when a bill of exchange document is printed.

After a successful transfer operation in step 112, the process of informing the legal representative can be added, which is step 113. The manual transfer operation terminal transmits the transfer operation results from the server in the bank to a short message transmitting/receiving module, then codes and sends short messages to the legal representative's mobile phone that has been bonded with the said bank account.

In the said method above, the said reserved certificates are the individual information related to the identity of account holders agreed upon by both the holder and the bank in advance, such as a fingerprint of the holder scanned and kept in the mobile phone as a reserved certificate, or a specific photo, or a picture drawn by the account holder, or the signature of the account holder, or the voice recorded by the mobile phone. All the above reserved certificates are sent to the bank confirming module by the mobile phone to identify the accountholder's identity by recognizing the corresponding picture and/or voice.

In the said method above, the said reserved certificates and confirming module can be corresponded in the following ways:

The said reserved certificates are a passport written in numbers and English letters, and the said confirming module is a device for differentiating the passport of numbers and letters.

The said reserved certificates are the specific voice or music recorded by the account holder, and the said confirming module is a telephone recording device or an audio frequency recognition device.

The said reserved certificates are the account holder's mobile phone number or the international mobile equipment identity of a mobile phone, and the said confirming module is a recognition device for the account holder's electronic character.

The said reserved certificate is the account holder's fingerprint, and the said confirming module is a fingerprint recognition device.

The said reserved certificate is the account holder's signature or seal, and the said confirming module is a signature recognition device.

The said reserved certificate is an appointed picture by the account holder, and the said confirming module is a picture recognition device.

In the said method above, the said confirming module receives the specific word, picture or voice short messages sent from the account holder's mobile phone and compares and identifies it with the reserved certificates kept in the confirming module.

The said method according to the present invention that realizes fund transfer by mobile telephone short message confirming mode may also be Schematically illustrated in FIG. 3.

Initially, the enterprise opens a credit card account in the bank that is bonded with the mobile phone of the enterprise's legal representative, which is step 201.

Next, the enterprise's legal representative stipulates the reserved certificates with the bank and saves them in a confirming module, which is step 202.

When people transfer funds with a check or draft from the enterprise, the bank staff inputs the enterprise's bank account to a manual transfer operation terminal after confirming that the seal of the check or draft is the same as that reserved in the bank by the enterprise. A manual transfer operation terminal sends the transfer request message to the short message transmitting/receiving module through a special network or an inner interface which is step 203. The short message transmitting/receiving module receives and analyzes the transfer request information from a transfer operation terminal, then codes and sends short messages to the legal representative's mobile phone that have been bonded with the said enterprise's bank account, which is step 104, and the contents of the short message contain related information such as the bank account number, the volume of the transfer fund, and the fund receiving account or institution. The bank manual confirming module automatically examines whether the confirming call from the legal representative's mobile phone is received, which is step 205. If the confirming call from the legal representative is received, the confirmation of the legal representative's identity would be conducted, which is step 206; otherwise, it feeds back to the manual transfer operation terminal, which is step 207, and the transfer operation is terminated. If the legal representative is identified, the bank manual confirming module sends the transfer operation command to the bank transfer business-processing module according to the account holder's orders, which is step 208; otherwise, it feeds back to a transfer operation terminal, which is step 209, and the transfer operation terminates. The bank transfer business-processing module receives and deals with a transfer operation command from a confirming module through a special network, and then feeds back the results of a transfer operation to a transfer operation terminal through a server in bank, which is step 210, and the transfer operation terminates when the bill of exchange document is printed.

After a successful transfer operation in step 210, the process of informing the legal representative can be added, which is step 211. The manual transfer operation terminal transmits the transfer operation results from the server in the bank to a short message transmitting/receiving module, then codes and sends short messages to the legal representative's mobile phone that has been bonded with said bank account.

1. A system that transfer funds by a mobile telephone short message confirming mode comprising a server in a bank, a confirming module, a bank transfer business-processing module, a transfer operation terminal, and a short message transmitting/receiving module;
said server in said bank is deposited when the bank accounts are opened by the account holders as financial accounts that are bonded with the mobile phone of the holders; the said server in the bank is connected to the confirming module and the bank transfer business-processing module through a special network;
said confirming module is reserved with certificates that the account holder left at the bank, and receives and analyzes confirmation messages regarding fund transfers from the account holder's mobile phone, which is transmitted from the said server in the bank, then the confirming module compares and differentiates the said message with those left at the bank before to identify the account holder and send transfer operation commands to the bank transfer business-processing module according to the request of account holders; the said reserved certificates contain individual information related to the identity of the account holders agreed upon by both the holder and the bank in advance;
said bank transfer business-processing module receives and deals with transfer operation commands from the said confirming module and then feeds back the transfer operation results to the said transfer operation terminal through a server in the bank;
said transfer operation terminal which is connected to a said server in the bank through the public Internet or a special network, receives transfer operation results from a transfer operation terminal; the said transfer operation terminal is connected to the short message transmitting/receiving module and delivers the transfer request message thereto;
said short message transmitting/receiving module, which is equipment used to deliver and receive short messages, is connected to the said server in the bank through the public or special network; the said short message transmitting/receiving module receives and analyzes the transfer request messages from the said transfer operation terminals, then codes and sends short messages to the said account holders' mobile phone that has been bonded with the bank account. The module automatically examines and receives confirmation messages from the account holders' mobile phone and then transmits the message to the said server in the bank.

2. The system that transfer funds by a mobile telephone short message confirming mode according to claim 1, wherein said transfer operation terminal transmits the fund transfer results from a server in the bank to the said short message transmitting/receiving module, and then codes and sends short messages to the said account holders' mobile phone, that has been bonded with the bank account.

3. The system that transfer funds by a mobile telephone short message confirming mode according to claim 1, wherein said bank account is at least one of the following: an individual credit card account, an individual saving account, an enterprise account, an inter-bank deposit and a national treasury account.

4. The system that transfer funds by a mobile telephone short message confirming mode according to claim 1, wherein said short message is at least one of the following: word message, voice message, image message and the combination thereof.

5. The system that transfer funds by a mobile telephone short message confirming mode according to claim 1, wherein said transfer operation terminal is at least one of the following:
the card-sliding transfer operation terminal in the consumer market,
the card-sliding transfer operation terminal at the bank business counter, and
a manual transfer operation terminal at the bank business counter.

6. The system that transfer funds by a mobile telephone short message confirming mode according to claim 1, wherein said transfer operation terminal and the short message transmitting/receiving module being collected by a special network.

7. The system that transfer funds by a mobile telephone short message confirming mode according to claim 1, wherein said transfer operation terminal and the short message transmitting/receiving module being combined into a device and they are connected to each other through an inner interface.

8. The system that transfer funds by a mobile telephone short message confirming mode according to claim 1, wherein said short message transmitting/receiving module is at least one of the following: a mobile phone or a telephone which contains the chip or software for transmitting/receiving short messages, a computer which can transmit a mobile phone short message through the Internet, and a specially manufactured device to transmit and receive short messages.

9. The system that transfer funds by a mobile telephone short message confirming mode according to claim 1, wherein said reserved certificates using a passport written with numbers and English letters, and the said confirming module having a device that differentiates between passport numbers and letters.

10. The system that transfer funds by a mobile telephone short message confirming mode according to claim 1, wherein said reserved certificates being the specific voice or music recorded by the account holder, and the said confirming module being a telephone recording device or an audio frequency recognition device.

11. The system that transfer funds by a mobile telephone short message confirming mode according to claim 1, wherein said reserved certificates being the holder's mobile phone number or the international mobile equipment's identity of the mobile phone, and the said confirming module being a recognition device for the account holder's electronic character.

12. The system that transfer funds by a mobile telephone short message confirming mode according to claim 1, wherein said reserved certificate being the account holder's fingerprint and the said confirming module being a fingerprint recognition device.

13. The system that transfer funds by a mobile telephone short message confirming mode according to claim 1, wherein said reserved certificate being the account holder's signature or seal, and the said confirming module being a signature recognition device.

14. The system that transfer funds by a mobile telephone short message confirming mode according to claim 1, wherein said reserved certificate being the appointed picture by the account holder, and the said confirming module being a picture recognition device.

15. The system that transfer funds by a mobile telephone short message confirming mode according to claim 1, wherein said confirming module being the bank's manual confirming module.

16. A method for realizing fund transfer by a mobile telephone short message confirming mode comprising the steps of:
(a) the account holder opens a bank account in a bank that is bonded with his mobile phone;
(b) the account holder stipulates the reserved certificates with the bank and saves them in a confirming module;
(c) the transfer operation terminal sends the transfer request information to the short message transmitting/receiving module through a special network or an inner interface;
(d) the short message transmitting/receiving module receives and analyzes the transfer request information from a transfer operation terminal, then codes and sends short messages to the account holder's mobile phone that has been bonded with the bank account;
(e) the short message transmitting/receiving module automatically examines whether the confirming short messages sent by the account holder are received; if the confirming short message is received, the short message transmitting/receiving module sends the message to a server in the bank through a special network or the public Internet; otherwise a short message transmitting/receiving module feeds back to the transfer operation terminal and the transfer operation is terminated;
(f) the server in the bank receives and transfers the confirming messages to the confirming module, which includes the information about the examination of the account holder's identity and the transfer confirmation message;
(g) the confirming module compares and identifies the examination information of the account holder's identity with the reserved certificate; if the accountholder's identity is confirmed, the confirming module sends the transfer operation command to the bank transfer business-processing module according to the account holder's orders; otherwise, the confirming module feeds back to the transfer operation terminal through the server in the bank and the transfer operation terminates; and
(h) the bank transfer business-processing module receives and deals with the transfer operation commands from the confirming module through a special network, and then feeds back the results of the transfer operation to a transfer operation terminal through a server in the bank.

17. The method for realizing fund transfer by a mobile telephone short message confirming mode according to claim 16, further comprising the step of: after said step h, the said transfer operation terminal transmits the transfer operation results from the server in the bank to the said short message transmitting/receiving module, and then codes and sends short messages to the account holder's mobile phone that has been bonded with the bank account.

18. The method for realizing fund transfer by a mobile telephone short message confirming mode according to claim 16, wherein said step e, the said short message transmitting/receiving module set up with an automatic test parameter including the test times and the distant time of each test.

19. A method for realizing fund transfer by a mobile telephone short message confirming mode comprising the steps of:
(a) the account holder opens a bank account in the bank which is bonded with his mobile phone;
(b) the account holder stipulates the reserved certificates with the bank and saves them in a confirming module;
(c) the transfer operation terminal sends the transfer request information to the short message transmitting/receiving module through a special network or an inner interface;
(d) the short message transmitting/receiving module receives and analyzes the transfer request information from the transfer operation terminal, codes and sends short messages to the account holder's mobile phone that has been bonded with the bank account;
(e) the bank manual confirming module automatically examines whether the confirming call made by the account holder is received; if the confirming call is received, the identification of the account holder's identity is conducted; otherwise, the information is fed back to a transfer operation terminal and the transfer operation is terminated;
(f) if the account holder's identity is confirmed, the bank manual confirming module sends the transfer operation command to a bank transfer business-processing module according to the account holder's orders; otherwise, it is fed back to the transfer operation terminal through a server in the bank and the transfer operation terminates; and
(g) the bank transfer business-processing module receives and deals with the transfer operation commands from the confirming module through a special network, and then feeds back the results of the transfer operation to the transfer operation terminal through a server in the bank.

20. The method for realizing fund transfer by a mobile telephone short message confirming mode according to claim 19, further comprising the step of: after the step g, the said transfer operation terminal transmits the transfer operation results from the server in the bank to the said short message transmitting/receiving module, and then codes and sends short messages to the account holder's mobile phone that has been bonded with the bank account.

21. The method for realizing fund transfer by a mobile telephone short message confirming mode according to claim 19, wherein said step e, the bank manual confirming module being set up with an automatic examination parameter including the test times and the distant time of each test.
